(19) United States
(12) Patent Application Publication
(10) Pub. No.: US 2004/0211714 A1
(43) Pub. Date: Oct. 28, 2004

(54) Wastewater treatment apparatus

(76) Inventor: Jeremy Wickins, Sussex (GB)

Correspondence Address: Cook, Alex, McFarron, Manzo,, Cummings & Mehler, Ltd., Suite 2850, 200 W. Adams Street, Chicago, IL, 60606, US

(21) Appl. No.: 10/758,152

(22) Filed: Jan. 15, 2004

(30) Foreign Application Priority Data
Jan. 17, 2003 (GB) 0301092.3

(51) Int. Cl. C02F 3/02

(52) U.S. Cl. 210/137; 210/151; 210/220; 210/620; 210/86

(57) ABSTRACT

Wastewater treatment apparatus comprising at least one pre-tank and a reactor tank between which a transfer connection is provided to enable wastewater to be transferred from the or each pre-tank to the reactor tank. The reactor tank is provided with a biomass and aeration equipment to enable the wastewater to be treated in the reactor tank. The capacity of the pre-tank or pre-tanks enables it or them to retain the storm flow for a sufficient period of time. The or one of the pre-tanks is provided with a storm overflow, whereby even in storm conditions the reactor tank remains effective and settled solids from the storm flow in the pre-tank or one of the pre-tanks are transferred at intervals to the reactor tank. In the event of persistence of the storm conditions, excess wastewater is released via the storm overflow without interrupting operation of the reactor tank.

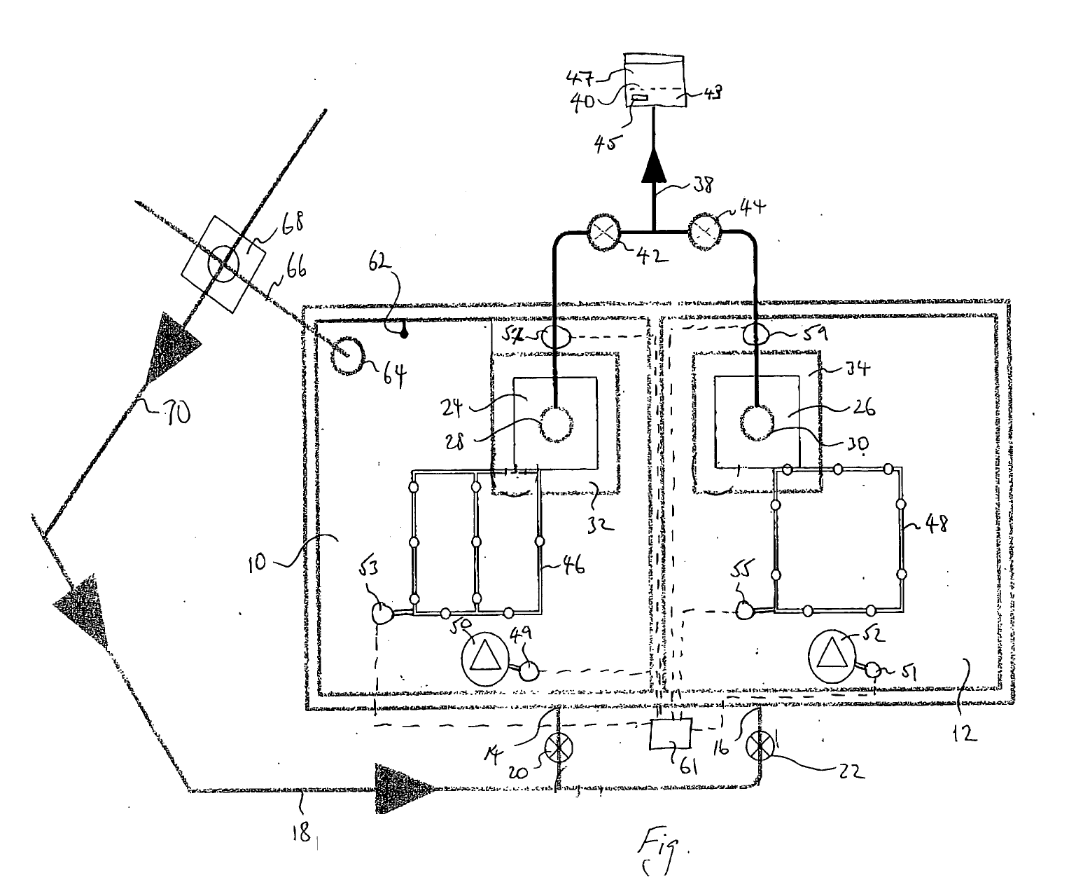

The present invention relates to wastewater treatment apparatus comprising at least one pre-tank and a reactor tank between which a transfer connection is provided to enable wastewater to be transferred from the or each pre-tank to the reactor tank, and in which the reactor tank is provided with a biomass and aeration equipment to enable the wastewater to be treated in the reactor tank.

It is established practice in the water industry to determine the capacity of the apparatus for dealing with storm conditions in terms of the flow the apparatus has to deal with in dry weather. Thus, to deal with storm conditions, the apparatus is further provided with storm tanks, and overflows or weirs are provided to feed excess flow to these storm tanks. Normally, at least two storm tanks are provided, with the second storm tank beginning to fill after the first has been filled. This increases the likelihood that solids will settle in these storm tanks. However, in the event that the storm tanks cannot cope with the storm conditions, ultimately water overflows from the second storm tank through a screen and into a river or stream. Typically, the storm tanks are required to be capable of containing the amount of wastewater that flows at, say, three times the dry weather flow for a period of at least two hours.

After the storm subsides, the contents of the storm tanks are passed back to the apparatus for treatment, with scraping equipment in the storm tanks to scrape solids settled off the bottom, also to be returned to the treatment apparatus. This also requires odour control in addition to duty stand-by of all the pumps and equipment.

The provision of storm tanks, scraping equipment and odour control all increase the cost of the apparatus.

The present invention seeks to provide a remedy.

Accordingly, the present invention is directed to wastewater treatment apparatus having the construction set out in the opening paragraph of the present specification, wherein the capacity of the pre-tank or pre-tanks enables it or them to retain the storm flow for a sufficient period of time and wherein the or one of the pre-tanks is provided with a storm overflow, whereby even in storm conditions the reactor tank remains effective and settled solids from the storm flow in the pre-tank or one of the pre-tanks are transferred at intervals to the reactor tank, and in the event of persistence of the storm conditions, excess wastewater is released via the storm overflow without interrupting operation of the reactor tank.

Preferably, the or each pre-tank is provided with a stirrer. This provides the means to maintain a degree of homogeneity of the wastewater in non-storm conditions. Instead of or in addition to the stirrer there may be provided aeration equipment in the or each pre-tank.

At least one of the pre-tanks may be provided with a level sensor to switch-off such a stirrer and/or aeration equipment once the level of the wastewater in that tank rises above a predetermined level.

This increases the likelihood that solids will settle in the or each pre-tank in storm conditions. The position at which the transfer connection opens into the or each pre-tank may be provided with a cover to reduce the turbulence of fluid within that tank, so that it is not unduly unsettled in storm conditions, when transfer takes place.

The or each cover may comprise a plate.

The storm overflow may comprise a weir as a simple means of dealing with excess wastewater.

There may be two pre-tanks connected together via the transfer connection. Preferably, with two such tanks, they are provided with respective inlets, each with its own shut-off valve, as well as two outlets to the transfer connection also with respective shut-off valves. This enables one tank to be isolated from the rest of the apparatus and serviced whilst the other pre-tank remains in operation, which in turn enables the apparatus to be serviced without being shut down. In the event of storm conditions, the inlet to one of the pre-tanks may then be closed so that the flow is directed into only one of the pre-tanks for initial settlement. Once that tank cannot accommodate further flow, both shut-off valves of the outlets can be opened to enable fluid to flow into the other of the pre-tanks before, ultimately, excess flow flows out through the storm overflow.

The present invention extends to a method of treating wastewater comprising feeding wastewater to at least one pre-tank from which it is fed at intervals to a reactor tank containing a biomass and aeration equipment to treat the wastewater wherein the pre-tank or pre-tanks has or have a capacity to enable it or them to retain storm flow for a sufficient period of time whilst the reactor tank remains effective and settled solids in the pre-tank or one of the pre-tanks are transferred at intervals to the reactor tank and wherein in the event of persistence of storm conditions, excess wastewater is released via a storm overflow provided in the or one of the pre-tanks without interrupting operation of the reactor tank.

An example of wastewater treatment apparatus embodying the present invention will now be described with reference to the accompanying drawing, the only FIGURE of which shows the apparatus in diagrammatic plan form.

The apparatus shown in the only FIGURE of the drawings comprises two pre-tanks 10 and 12 provided with respective inlets 14 and 16 connected to a common feed line 18 via respective shut-off valves 20 and 22. At the base of each pre-tank 10 and 12 there is a sump 24 and 26 respectively leading to respective outlets 28 and 30. The sump and the outlets are covered by respective cover plates 32 and 34 with a relatively small spacing between the plates and the base of the pre-tanks 10 and 12. The outlets 28 and 30 are in turn reconnected to a common transfer line 38 to a reactor tank 40 via respective shut-off valves 42 and 44.

The reactor tank 40 is provided with a biomass 43 and aeration equipment 45 to enable wastewater 47 in the reactor tank 40 to be treated therein.

The base of each pre-tank 10 and 12 is provided with an aerator 46 and 48, respectively, and also a mechanical stirrer 50 and 52, respectively. The stirrers are provided with respective motors 49 and 51. Pumps 53 and 55 are also provided for each aerator 46 and 48 to pump air therethrough and pumps 57 and 59 are also provided to pump wastewater from each pre-tank 10 and 12 to the transfer line 38.

Control of the motors and pumps is determined by a microprocessor 61. In addition, the output of a level sensor 62 provided in the pre-tank 10 is connected to that processor.

An overflow weir 64 is provided at a higher level in the pre-tank 10. This discharges wastewater via a discharge line 66 and a screen 68 to a river or stream 70.

Under normal conditions of flow, for example in dry weather conditions, wastewater is fed by the feed line 18 to the pre-tanks 10 and 12 via the inlets 14 and 16. The wastewater in these pre-tanks is continually moved around by the stirrer 50 and 52 and the aerators 46 and 48. Under a pre-selective regime, the microprocessor 61 causes the appropriate pump to operate to transfer wastewater from the pre-tanks 10 and 12 to the reactor tank 40.

In the event that the pre-tanks require servicing and cleaning, one of them is isolated by shutting off its inlet and outlet shut-off valve, whilst the other continues to operate. Normally, however, both shut-off valves 42 and 44 are open so that the wastewater is balanced equally between the two pre-tanks 10 and 12.

During storm conditions, wastewater rises in the pre-tanks 10 and 12 at a rate faster than the transfer of wastewater to the reactor tank 40. Once the level exceeds that determined by the sensor 62, the signal to the microprocessor 61 causes the stirrers 50 and 52 and the aerators 46 and 48 to be stopped so that they no longer stir up solids in the tanks. As a result, as the water level in the pre-tanks rises, sludge and solids more easily settle in these tanks. Sludge is removed from the pre-tanks under the normal treatment regime via the transfer line 38 to the reactor 40. The cover plates 32 and 34 reduce the turbulence caused when sludge is drawn off from the pre-tanks 10 and 12 to the reactor tank 40, reducing the extent to which the sludge and solids which remain in the pre-tanks during storm conditions are disturbed.

In the event that the storm conditions persist, ultimately water flows out of the pre-tank 10 into the river 70 via the line 66 and the screen 68. The latter prevents undesirable solids entering into the river or stream. At the same time, shut-off valves 42 and 44 remain open so that the levels in the pre-tanks 10 and 12 remain substantially equal.

Once the storm conditions have subsided, some of the biomass in the reactor tank 40 may be fed back to the reactor tanks 10 and 12 to assist the apparatus in dealing with the increased load from the storm. However, it will be appreciated that as a result of the construction of the illustrated apparatus, no additional storm tanks are required, and no cleaning or scraping of any such storm tanks is required.

Many modifications and variations to the illustrated apparatus may occur to the reader without taking it outside the scope of the present invention. To give one example only, each pre-tank 10 and 12 could be provided with its respective overflow weir 64.

I claim:

1. Wastewater treatment apparatus comprising at least one pre-tank and a reactor tank between which a transfer connection is provided to enable wastewater to be transferred from the said at least one pre-tank to the reactor tank, and in which the reactor tank is provided with a biomass and aeration equipment to enable the wastewater to be treated in the reactor tank, wherein the capacity of the said at least one pre-tank enables it to retain the storm flow for a sufficient period of time and wherein the said at least one pre-tank is provided with a storm overflow, whereby even in storm conditions the reactor tank remains effective and settled solids from the storm flow in the said at least one pre-tank are transferred at intervals to the reactor tank, and in the event of persistence of the storm conditions, excess wastewater is released via the storm overflow without interrupting operation of the reactor tank.

2. Wastewater treatment apparatus according to claim 1, wherein the said at least one pre-tank is provided with a stirrer.

3. Wastewater treatment apparatus according to claim 1, wherein aeration equipment is provided in the said at least one pre-tank.

4. Wastewater treatment apparatus according to claim 2, wherein aeration equipment is provided in the said at least one pre-tank.

5. Wastewater treatment apparatus according to claim 2, wherein the said at least one pre-tank is provided with a level sensor to switch-off the stirrer once the level of the wastewater in that tank rises above a predetermined level.

6. Wastewater treatment apparatus according to claim 3, wherein the said at least one pre-tank is provided with a level sensor to switch-off the aeration equipment once the level of the wastewater in that tank rises above a predetermined level.

7. Wastewater treatment apparatus according to claim 4, wherein the said at least one pre-tank is provided with a level sensor to switch-off the stirrer and the aeration equipment once the level of the wastewater in that tank rises above a predetermined level.

8. Wastewater treatment apparatus according to claim 1, wherein the position at which the transfer connection opens into the said at least one pre-tank is provided with a cover to reduce the turbulence of fluid within that tank, so that it is not unduly unsettled in storm conditions, when transfer takes place.

9. Wastewater treatment apparatus according to claim 8, wherein the cover comprises a plate.

10. Wastewater treatment apparatus according to claim 1, wherein the storm overflow comprises a weir.

11. Wastewater treatment apparatus according to claim 1, wherein there are two pre-tanks connected together via the transfer connection.

12. Wastewater treatment apparatus according to claim 11, wherein the two pre-tanks are provided with respective inlets, each with its own shut-off valve, as well as two outlets to the transfer connection also with respective shut-off valves.

13. A method of treating wastewater comprising feeding wastewater to at least one pre-tank from which it is fed at intervals to a reactor tank containing a biomass and aeration equipment to treat the wastewater, wherein the said at least one pre-tank has a capacity to enable it to retain storm flow for a sufficient period of time whilst the reactor tank remains effective and settled solids in the said at least one pre-tank are transferred at intervals to the reactor tank and wherein in the event of persistence of storm conditions, excess wastewater is released via a storm overflow provided in the said at least one pre-tank without interrupting operation of the reactor tank.
